(19) United States
(12) Patent Application Publication
(10) Pub. No.: US 2011/0129907 A1
(43) Pub. Date: Jun. 2, 2011

(54) Method of conversion of biodegradable, hygienically non-stabilized substrate into hygienically stabilized product

(75) Inventors: Václav Holusa, Dolni Lhota (CZ); David Sindelár, Ostrava-Poruba (CZ); Petr Vanícek, Jindrichovice pod Smrkem (CZ)

(73) Assignee: AGRO-EKO SPOL., Ostrava-Pustkovec (CZ)

(21) Appl. No.: 13/024,342

(22) Filed: Feb. 10, 2011

Related U.S. Application Data
(63) Continuation-in-part of application No. 12/090,479, filed on Apr. 16, 2008.

(51) Int. Cl. B09B 3/00

(52) U.S. Cl. 435/262.5

(57) ABSTRACT

A method for treating hygienically unstable waste is disclosed. Waste is allowed to aerobically ferment for approximately 36 hours at a temperature of 40 to 50° C. During aerobic fermentation, an external air supply maintains the appropriate temperature, while restacking of the substrate ensures uniform oxygen distribution. After approximately 36 hours of aerobic fermentation, the amount of externally supplied air is decreased, leading to a gradual temperature rise. The substrate is kept at a temperature range of 70 to 80° C. for a period of 30 to 60 minutes, followed by intensive aeration which is performed until the maximum moisture content of 10% is reached. The waste has then been converted to a hygienically stabilized product.

### Cross-Reference to Related Applications

This application is a continuation-in-part of U.S. Patent Application No. 12/090,479 filed on Nov. 16, 2005, which is hereby incorporated by reference for all purposes.

### TECHNICAL FIELD

The invention concerns a method of biological waste processing, particularly waste which is able to contaminate the environment, smell producing waste and hygienically objectionable waste, and it solves hygiene security for further handling of such waste. Hygienically stabilized substrate can be subsequently processed avoiding the danger of environmental damage, e.g. by composting or use as a fuel.

### DESCRIPTION OF PRIOR ART

It is known that waste of biological origin is stored in dumping grounds. The disadvantage of dumping is its growing space demand while the dumping grounds operation rules are getting stricter. It is also known that waste of biological origin is composted without further treatment. The disadvantage of composting without prior treatment is that the processed material only becomes hygienically unobjectionable after several months. The disadvantage of both dumping and composting is that biological waste in dumping and composting grounds usually represents increased danger, mainly through contamination of subsoil water, leaking smell or, due to its conditional pathogenicity, it is a potential source of infection. It is also known that biological waste can be burnt whereas the high volume of water in the burnt material is unwanted because the fuel efficiency is reduced with the growing volume of water. With a high volume of water the fuel becomes non-flammable. It is further known that biological waste can be aerobically fermented. CZ patent 286614 concerns a method of processing a mixture of waste-water treatment plant sludge and solid biological waste, e.g. wooden chips, sawdust or separated municipal biological waste. The given mixture making up the substrate is subjected to a 2-to 4-day aerobic fermentation after which it is dried to a dry matter content of 70 to 90% and afterwards it is granulated or made into briquettes. The process produces a fuel. A disadvantage of this method is that making the whole volume of substrate hygienically unobjectionable is not secured because the process is not performed in a closed environment, thermally insulated from the surrounding. Therefore a heat leakage occurs, which results in a lower temperature near the surface of the substrate where the fermentation process does not take place intensively enough and, therefore, the total time of processing is longer. Another disadvantage is that when handling the substrate, pathogenic organisms are spread into the environment along with evaporating water, aerosols and solid matter. Another disadvantage is energy demand of the process because an external source of heat is necessary for the substrate drying.

### DISCLOSURE OF INVENTION

The above-mentioned disadvantages are solved by the method of conversion of biodegradable, hygienically non-stabilized substrate into hygienically stabilized product according to the present disclosure. The substrate is placed in a space separated from the surrounding atmosphere and then subjected to an aerobic fermentation. The aerobic fermentation includes a step of exposing the entire volume of the substrate to a temperature range of 70° C. to 80° C. for a period of 30 to 60 minutes. The substrate temperature can also be controlled during fermentation by the amount of externally supplied air and the frequency of moving the substrate layers.

An advantage of the method according to the invention is that biological waste is converted into a raw material which is not biologically active, it does not contaminate the environment and it is not a source of an annoying smell. Another advantage is a short processing time, so the equipment in which the method is performed need not be inadequately large, nor functioning at a high production capacity. An advantage is also low energy demand as no external source of heat is necessary for the process to take place.

### EXAMPLES OF EXECUTION OF THE INVENTION

### EXAMPLE 1

A substrate containing aerobic micro-organisms is comprised of a mixture of grain straw, chips and sludge from a municipal waste-water treatment plant in the volume ratio of 1: 1: 1.The substrate is placed into an enclosed, thermally insulated fermentation reactor which is equipped with air supply and discharge for produced gases.

The maximum size of inseparable particles in the substrate is 50 mm. The temperature of the substrate rises during the aerobic fermentation process and after eight hours the temperature in the fermentation reactor reaches 40° C. to 50° C. In this phase, water steam is discharged from the fermentation reactor. The fermentation is performed while moving the substrate layers and controlling the amount of externally supplied air for a period of 36 hours at this temperature range. Fermentation in the entire volume of the substrate at the same time is conditioned upon uniform distribution of oxygen throughout the entire volume of the substrate. Uniform oxygen distribution is not possible without restacking the substrate during fermentation. In this context, restacking refers to removing compacted material from the bottom of the pile, for example by tipper cutter; transporting this material to the top of the pile, and spreading the material across the top of the pile. Restacking of the material of the pile is essential for compressing fermentation time. The rate of fermentation is controlled by the amount of externally supplied air based on measuring the temperature and detecting the CO₂ content in the discharging gases. Then the amount of externally supplied air is decreased, so a gradual temperature rise takes place for a period of 24 hours until a temperature range of 70° C. to 80° C. is reached. The substrate is kept at this temperature range for a period of 35 minutes. The next phase is intensive aeration which is performed until the maximum moisture content of 10% is reached.

### EXAMPLE 2

Example 2 differs from Example 1 in that the substrate is comprised of a mixture of 40% of sludge from the textile industry and 60% of rape straw.

### EXAMPLE 3

Example 3 differs from Example 1 in that the substrate is comprised of a mixture of 35% of sludge from paper and pulp production, 15% of wood shavings and saw dust, 20% of green chips, and 30% of rape straw.

### EXAMPLE 4

Example 4 differs from Example 1 in that the substrate is comprised of a mixture of 15% of sludge from starch processing, 25% of rape straw, 25% of wooden shavings and saw dust, 25% of green chips, and 10% of coniferous bark.

### EXAMPLE 5

Example 5 differs from Example 1 in that the substrate is comprised of a mixture of 50% of sludge from a municipal waste-water treatment plant, 25% of non-standard waste paper, and 25% of rape straw.

Kitchen waste, energy sorrel straw, crushed municipal waste, food industry waste or plastic substrate can also be used for the substrate.

All of the mentioned percents are percents by weight.

I claim:

1. A method of converting biodegradable hygienically non-stabilized substrate into hygienically stabilized product, comprising the steps of:
placing substrate into a space separated from the surrounding atmosphere;
putting the substrate through aerobic fermentation conditioned by externally supplied air;
wherein the aerobic fermentation involves the step of exposing the substrate to the temperature of 70° to 80° C.;
wherein the substrate is restacking during the aerobic fermentation;
wherein the step of exposing the substrate to the temperature of 70° to 80° C. proceeds in whole volume of the substrate at the same time; and
wherein the step of exposing the substrate to the temperature of 70° to 80° C. takes 30 to 60 minutes.

2. The method according to claim 1 wherein the temperature of the substrate during aerobic fermentation is controlled by the amount of externally supplied air and by the frequency of restacking of the substrate.

3. A method of converting biodegradable hygienically non-stabilized substrate into hygienically stabilized product, comprising the steps of:
placing substrate into a space separated from the surrounding atmosphere;
supplying enough air to the substrate to maintain a temperature of 40° to 50° C. for a period of approximately 36 hours;
concurrently restacking the pack for a period of approximately 36 hours;
decreasing the amount of air until a temperature of 70° to 80° C. is reached; and
maintaining the substrate at a temperature of 70° to 80° C. for a period of approximately 30 to 60 minutes.
